(19) United States
(12) Patent Application Publication
(10) Pub. No.: US 2020/0371543 A1
(43) Pub. Date: Nov. 26, 2020

(54) PEDAL PAD

(71) Applicant: DENSO CORPORATION, Kariya-city (JP)

(72) Inventors: Takuto KITA, Kariya-city (JP); Yasuhiro OOTAKA, Obu-city (JP)

(21) Appl. No.: 16/989,540

(22) Filed: Aug. 10, 2020

Related U.S. Application Data
(63) Continuation of application No. PCT/JP2019/005884, filed on Feb. 18, 2019.

(30) Foreign Application Priority Data
Feb. 23, 2018 (JP) 2018-030662

(51) Int. Cl. G05G 1/44; G05G 1/38

(52) U.S. Cl. CPC G05G 1/44; B60K 26/02; G05G 1/38

(57) ABSTRACT

A pedal pad is applied to a pedal device that outputs a signal corresponding to an operation amount of a depressing operation by an operator's foot. The pedal pad includes a pad member and a hinge member. The pad member is depressed by an operator's foot. The hinge member connects the pad member to a base of the accelerator device. The hinge member has a convex portion that is locked to the pad member and has a flat locking surface that is not perpendicular to the hinge shaft.

### CROSS REFERENCE TO RELATED APPLICATIONS

This application is a continuation application of International Patent Application No. PCT/JP2019/005884 filed on Feb. 18, 2019, which designated the U.S. and based on and claims the benefits of priority of Japanese Patent Application No. 2018-030662 filed on Feb. 23, 2018. The entire disclosure of all of the above applications is incorporated herein by reference.

### TECHNICAL FIELD

The present disclosure relates to a pedal pad.

### BACKGROUND

A pedal device detects an operation amount of a depressing operation by an operator's foot. The pedal device includes a pedal pad that is relatively movable with respect to a base of the pedal device by the depressing operation by the operator's foot.

### SUMMARY

An object of the present disclosure is to provide a pedal pad that can reliably prevent the pad member from coming off the hinge member while suppressing the increase in the size of the pad member and the hinge member.

The present disclosure is related to a pedal pad for applying to a pedal device that outputs a signal corresponding to an operation amount of a depressing operation by an operator's foot. The pedal pad includes a pad member and a hinge member. The pad member is depressed by an operator's foot. The hinge member connects the pad member and a base of the pedal device. In the pedal pad of the present disclosure, one of the pad member or the hinge member has a one-side convex portion or one-side concave portion that is locked to the other of the pad member or the hinge member, and that includes a planar locking surface not to be perpendicular with respect to a hinge shaft.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram showing an accelerator device;

FIG. 2 is a view taken along an arrow II of FIG. 1;

FIG. 3 is a front view of the pedal pad according to the first embodiment;

FIG. 4 is a cross-sectional view taken along a line IV-IV of FIG. 3;

FIG. 5 is a cross-sectional view taken along a line V-V of FIG. 3;

FIG. 6 is a front view of a pedal pad according to a second embodiment;

FIG. 7 is a cross-sectional view taken along a line VII-VII of FIG. 6;

FIG. 8 is a cross-sectional view taken along a line VIII-VIII in FIG. 6;

FIG. 9 is a front view of a pedal pad according to a third embodiment;

FIG. 10 is a cross-sectional view taken along a line X-X of FIG. 9;

FIG. 11 is a cross-sectional view taken along a line XI-XI of FIG. 9;

FIG. 12 is a front view of a pedal pad according to a fourth embodiment;

FIG. 13 is a cross-sectional view taken along a line XIII-XIII of FIG. 12;

FIG. 14 is a cross-sectional view taken along a line XIV-XIV of FIG. 12;

FIG. 15 is a front view of a hinge member for a pedal pad according to a fifth embodiment;

FIG. 16 is a cross-sectional view taken along a line XVI-XVI in FIG. 15;

FIG. 17 is a front view of a hinge member of a pedal pad according to a sixth embodiment;

FIG. 18 is a cross-sectional view of a line XVIII-XVIII line of FIG. 17;

FIG. 19 is a front view of a hinge member for a pedal pad according to a seventh embodiment;

FIG. 20 is a cross-sectional view taken along a line XX-XX of FIG. 19;

FIG. 21 is a front view of a hinge member for a pedal pad according to an eighth embodiment;

FIG. 22 is a cross-sectional view taken along a line XXII-XXII of FIG. 21;

FIG. 23 is a front view of a hinge member of a pedal pad according to a ninth embodiment;

FIG. 24 is a view taken along an arrow XXIV in FIG. 23;

FIG. 25 is a cross-sectional view taken along a line XXV-XXV of FIG. 23;

FIG. 26 is a front view of a hinge member of a pedal pad according to a tenth embodiment;

FIG. 27 is a view taken along a line)(XVII of FIG. 26;

FIG. 28 is a cross-sectional view taken along a line XXVIII-XXVIII of FIG. 26;

FIG. 29 is a front view of a hinge member of a pedal pad according to an eleventh embodiment;

FIG. 30 is a cross-sectional view taken along a line XXX-XXX in FIG. 29;

FIG. 31 is a cross-sectional view taken along a line XXXI-XXXI of FIG. 29;

FIG. 32 is a front view of a pedal pad according to a twelfth embodiment;

FIG. 33 is a cross-sectional view taken along a line XXXIII-XXXIII of FIG. 32; and

FIG. 34 is a view taken along a line XXXIV of FIG. 32.

### DETAILED DESCRIPTION

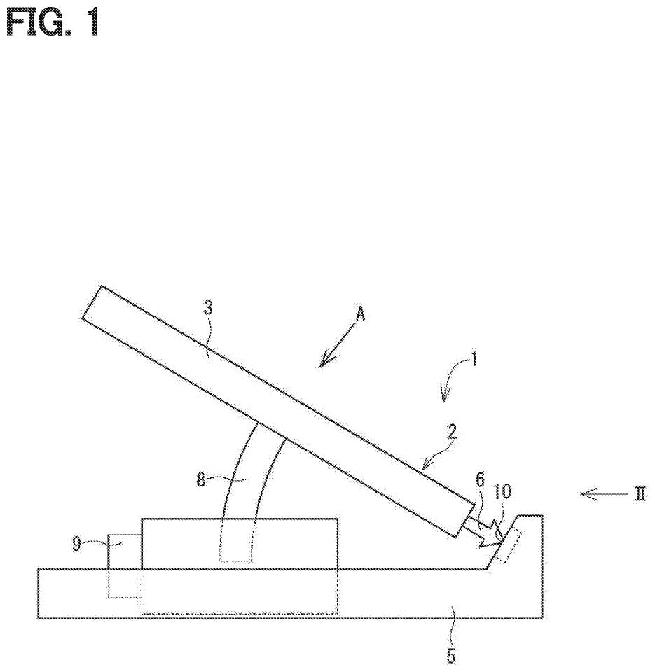

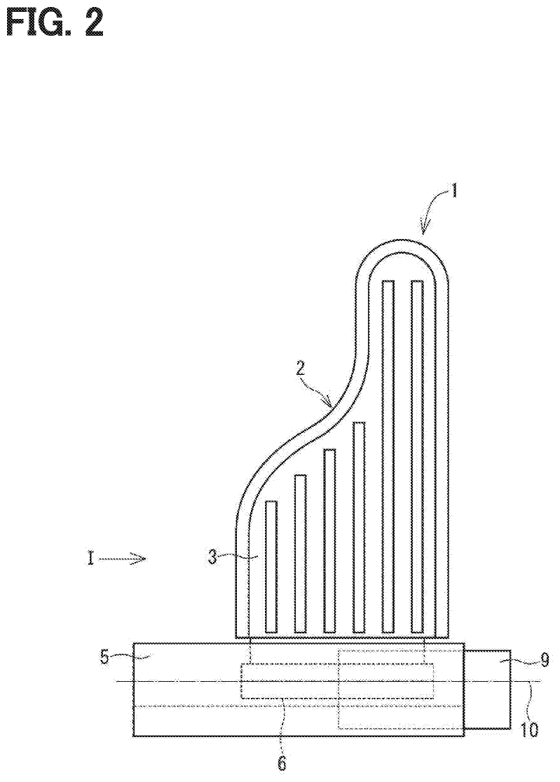

First, a configuration of an organ-type accelerator device as a “pedal device” to which a pedal pad of each embodiment described below is applied will be described. FIG. 1 is a view showing an accelerator device 1, and FIG. 2 is a view taken along an arrow II in FIG. 1. FIG. 1 is a view taken along an arrow I in FIG. 2. The accelerator device 1 is capable of outputting a signal corresponding to an amount of depression of the operator's foot. The accelerator device 1 includes a pedal pad 2, a base 5, a connecting member 8 for detection, and a rotation angle sensor 9.

The pedal pad 2 has a pad member 3 and a hinge member 6. The pad member 3 is formed in a plate shape so that the operator can perform a depressing operation with a foot. The hinge member 6 connects the pad member 3 and the base 5. The hinge member 6 is elastically deformed without being plastically deformed along a hinge shaft 10 shown in FIG. 2 by the depressing operation with the operator's foot. A detailed configuration of the pedal pad 2 will be described in each embodiment.

The base 5 is fixed so as to be relatively immovable with respect to a vehicle (not shown) on which the accelerator device 1 is mounted. Thereby, the pad member 3 is provided so as to be movable relative to the vehicle.

The connecting member 8 for detection is provided on the base 5 side of the pad member 3. The connection member 8 for detection is provided so as to be movable integrally with the pad member 3. The connecting member 8 for detection is inserted into the rotation angle sensor 9 provided on the base 5.

The rotation angle sensor 9 detects a length in which the connecting member 8 for detection is inserted. The rotation angle sensor 9 detects a rotation angle of the pad member 3 with respect to the base 5 in accordance with a length in which the connecting member 8 for detection is inserted.

Hereinafter, multiple embodiments of the present disclosure will be explained with reference to the drawings. In the following embodiments, the same reference numerals are given to such portions, which are the same or similar to each other, in order to avoid a repeated explanation.

### First Embodiment

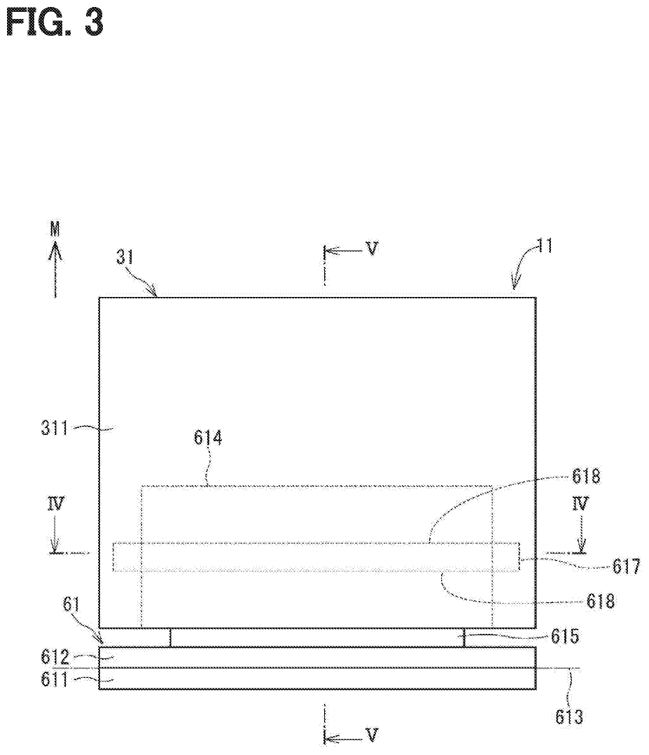

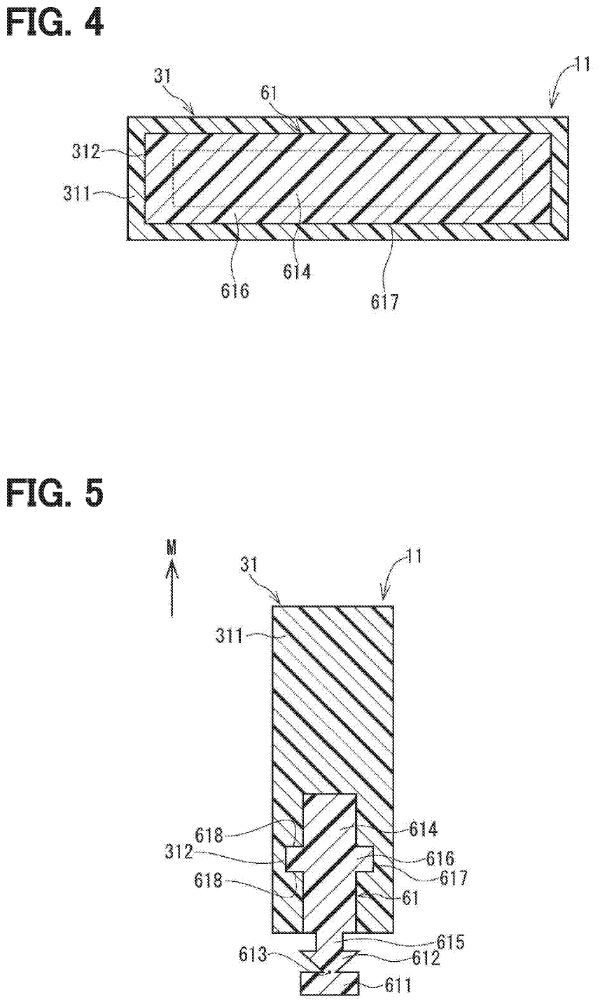

The pedal pad according to the first embodiment will be described with reference to FIGS. 3 to 5. FIG. 3 is a front view of the pedal pad 11 of the first embodiment, and is a view of the pedal pad 11 viewed from an angle corresponding to the direction A in FIG. 1. FIG. 4 is a cross-sectional view taken along a line IV-IV of FIG. 3, and FIG. 5 is a cross-sectional view taken along a line V-V of FIG. 3.

The pedal pad 11 according to the first embodiment has substantially the same appearance as the pedal pad 2 shown in FIGS. 1 and 2, and each member is represented by a simple shape in FIGS. 3 to 5. For example, the pad member 31 has substantially the same appearance as the pad member 3, but has an outer shape represented by a plate-like quadrangular prism shape. That is, FIGS. 3 to 5 show the pedal pad 11 that is composed of a combination of the pad member 31 and the hinge member 61.

The hinge member 61 has a thinnest hinge shaft 613 between a bottom portion 611 and a thickness adjusting portion 612 having a triangular cross section (see FIG. 5). In the present embodiment, the hinge shaft 613 is provided so as to extend in a direction perpendicular to a removal direction M of the pad member 31 with respect to the hinge member 61. On an opposite side of the thickness adjusting portion 612 with respect to the hinge shaft 613, a connecting portion 615 for connecting a fixing portion 614 fixed to the pad member 31 and the thickness adjusting portion 612 is provided. The substantially rectangular parallelepiped fixing portion 614 is provided with a convex portion 616 that protrudes in a direction substantially perpendicular to the direction M in which the pad member 31 is removed from the hinge member 61 and is formed in an annular shape. The convex portion 616 has a rectangular cross section (see FIG. 5) and is referred to as “one-side convex portion”. Other surfaces other than a top surface 617 among the surfaces forming the convex portion 616 are planar locking surfaces 618 formed non-parallel to the removal direction M of the pad member 31 with respect to the hinge member 61. That is, the locking surfaces 618 are formed so as to be non-perpendicular and flat with respect to the hinge shaft 613.

The pad member 31 has a main body 311 and a concave portion 312. The main body 311 is formed in a substantially concave shape so as to cover the fixing portion 614 and the convex portion 616 of the hinge member 61. The main body 311 is formed so that an operator's foot can be placed on the outside surface. The concave portion 312 is provided inside the main body 311 and is formed so as to be able to engage with the convex portion 616 of the hinge member 61.

In the pedal pad 11 according to the first embodiment, the convex portion 616 of the hinge member 61 has the planar locking surfaces 618 that are not perpendicular with respect to the hinge shaft 613. Thus, in the pedal pad 11, the locking force in the removal direction M of the pad member 31 with respect to the hinge member 61 can be made relatively large. Therefore, the first embodiment can surely prevent the pad member 31 from coming off the hinge member 61 while suppressing the increase in the size of the accelerator device 1.

Further, when the pedal pad 11 is applied to the organ-type accelerator device 1 for the vehicle, it is possible to prevent the physique of the accelerator device 1 from becoming large, so that it is possible to prevent deterioration in mountability on the vehicle.

### Second Embodiment

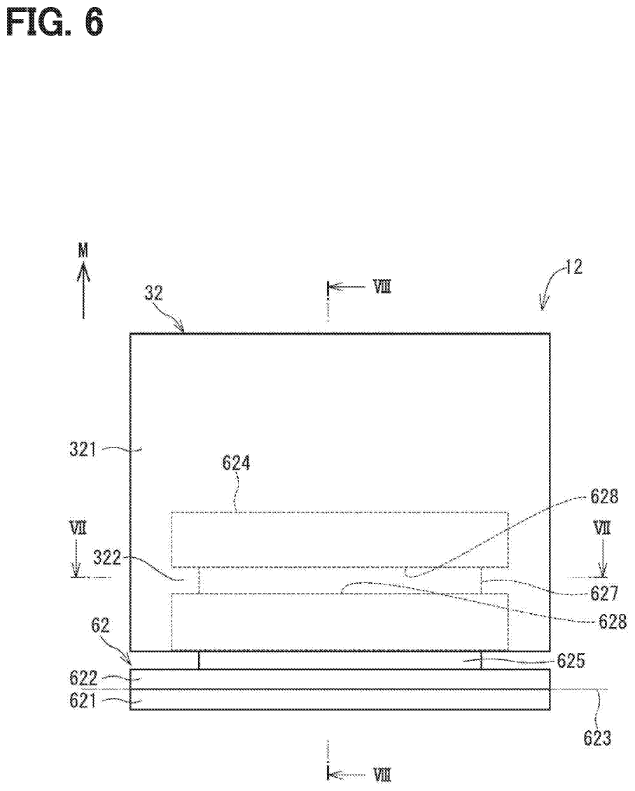

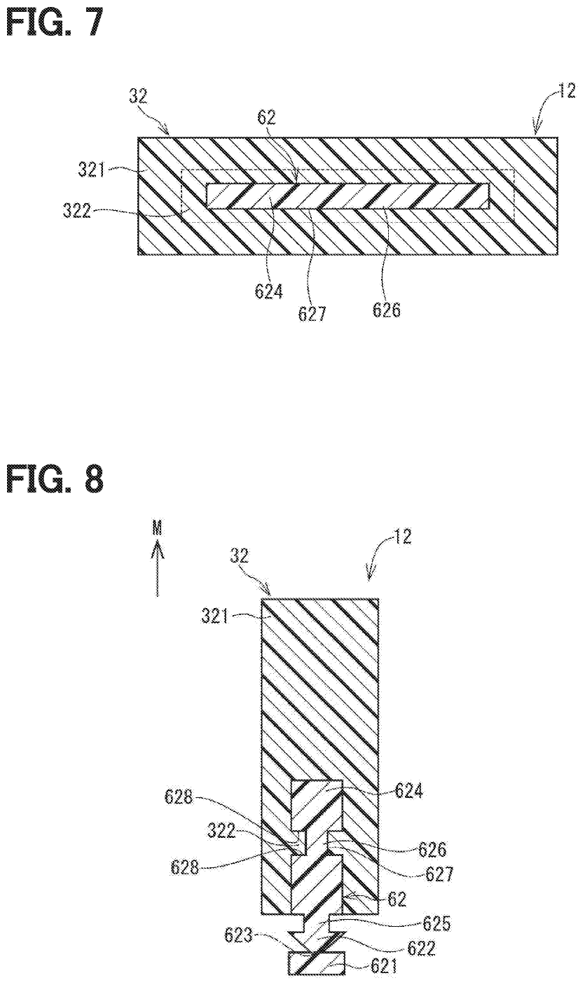

A pedal pad according to a second embodiment will be described with reference to FIGS. 6 to 8. FIG. 6 is a front view of the pedal pad 12 of the second embodiment, and is a view of the pedal pad 12 viewed from an angle corresponding to the direction A in FIG. 1. FIG. 7 is a cross-sectional view taken along a line VII-VII of FIG. 6, and FIG. 8 is a cross-sectional view taken along a line VIII-VIII of FIG. 6.

The pedal pad 12 according to the second embodiment has substantially the same appearance as the pedal pad 2 shown in FIGS. 1 and 2, and each member is represented by a simple shape in FIGS. 6 to 8. For example, the pad member 32 has substantially the same appearance as the pad member 3, but has an outer shape represented by a plate-like quadrangular prism shape. That is, FIGS. 6 to 8 show the pedal pad 12 that is composed of a combination of the pad member 32 and the hinge member 62.

The hinge member 62 has a thinnest hinge shaft 623 between a bottom portion 621 and a thickness adjusting portion 622 having a triangular cross section (see FIG. 8). In the present embodiment, the hinge shaft 623 is provided so as to extend in a direction perpendicular to a removal direction M of the pad member 32 with respect to the hinge member 62. On an opposite side of the thickness adjusting portion 622 with respect to the hinge shaft 623, a connecting portion 625 for connecting the fixing portion 624 fixed to the pad member 32 and the thickness adjusting portion 622 is provided. The substantially rectangular parallelepiped fixing portion 624 is provided with a concave portion 626 that is formed in a direction substantially perpendicular to the direction M in which the pad member 32 is removed from the hinge member 62 and is formed in an annular shape. The concave portion 626 has a rectangular cross section (see FIG. 8) and is referred to as “one-side concave portion”. Other surfaces other than a bottom surface 627 among the surfaces forming the concave portion 626 are planar locking surfaces 628 formed non-parallel to the removal direction M of the pad member 32 with respect to the hinge member 62. The locking surfaces 628 are formed so as to be non-perpendicular and flat with respect to the hinge shaft 623.

The pad member 32 has a main body 321 and a convex portion 322. The main body 321 is formed in a substantially concave shape so as to cover the fixing portion 624 and the concave portion 626 of the hinge member 62. The main body 321 is formed so that an operator's foot can be placed on the outside surface. The convex portion 322 is provided inside the main body 321 and is formed so as to be able to engage with the concave portion 626 of the hinge member 62.

In the pedal pad 12 according to the second embodiment, the concave portion 626 of the hinge member 62 has the planar locking surfaces 628 that are not perpendicular with respect to the hinge shaft 623. Thus, in the pedal pad 12, the locking force in the removal direction M of the pad member 32 with respect to the hinge member 62 can be made relatively large. Accordingly, the second embodiment obtains the same effects as the first embodiment.

### Third Embodiment

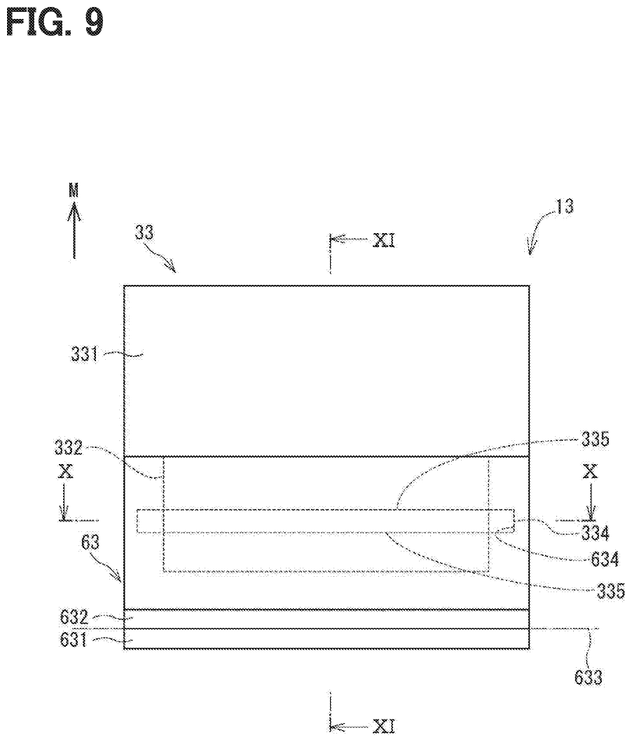

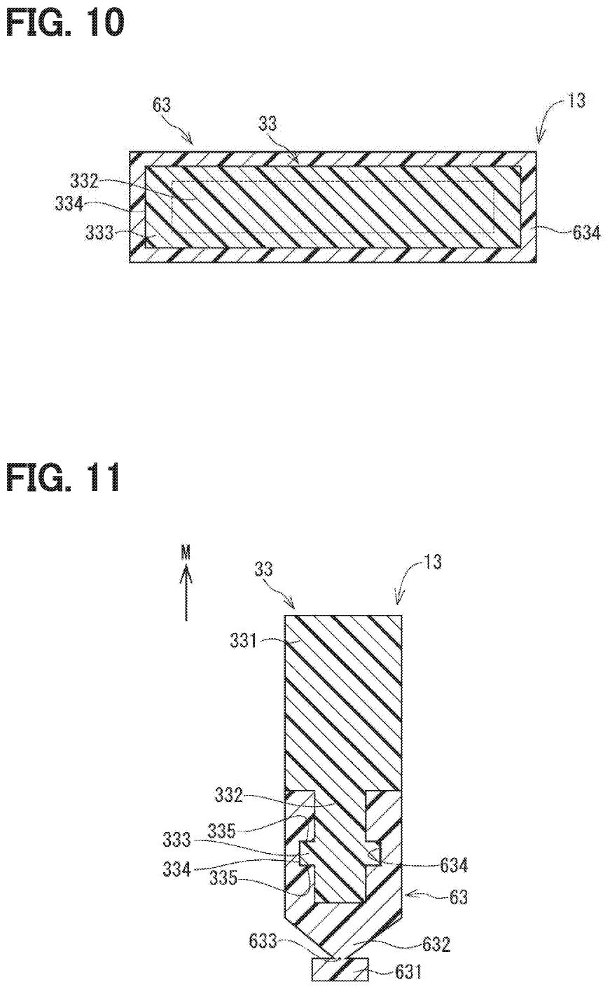

A pedal pad according to a third embodiment will be described with reference to FIGS. 9 to 11. FIG. 9 is a front view of the pedal pad 13 of the third embodiment, and is a view of the pedal pad 13 viewed from an angle corresponding to the direction A in FIG. 1. FIG. 10 is a cross-sectional view taken along a line X-X of FIG. 9, and FIG. 11 is a cross-sectional view taken along a line XI-XI of FIG. 9.

The pedal pad 13 according to the third embodiment has substantially the same appearance as the pedal pad 2 shown in FIGS. 1 and 2, and each member is represented by a simple shape in FIGS. 9 to 11. For example, the pad member 33 has substantially the same appearance as the pad member 3, but has an outer shape represented by two large and small plate-like quadrangular prism shapes. FIGS. 9 to 11 show the pedal pad 13 that is composed of a combination of the pad member 33 and the hinge member 63.

The pad member 33 has a thick part 331 and a thin part 332 that are substantially rectangular parallelepiped. The thick part 331 is formed so that an operator's foot can be placed on the outside surface. The thin part 332 is fixed to the hinge member 63. The thin part 332 is provided with a convex portion 333 that protrudes in a direction substantially perpendicular to the direction M in which the pad member 33 is removed from the hinge member 63 and is formed in an annular shape. The convex portion 333 has a rectangular cross section (see FIG. 11) and is referred to as “one-side convex portion”. Other surfaces other than a top surface 334 among the surfaces forming the convex portion 333 are planar locking surfaces 335 formed non-parallel to the removal direction M of the pad member 33 with respect to the hinge member 63. That is, the locking surfaces 335 are formed so as to be non-perpendicular and flat with respect to the hinge shaft 633.

The hinge member 63 has a thinnest hinge shaft 633 between a bottom portion 631 and a thickness adjusting portion 632 having a triangular cross section (see FIG. 11). In the present embodiment, the hinge shaft 633 is provided so as to extend in a direction perpendicular to a removal direction M of the pad member 33 with respect to the hinge member 63. On an opposite side of the thickness adjusting portion 632 with respect to the hinge shaft 633, the hinge member 63 has a concave portion 634 into which the thin part 332 and the convex portion 333 of the pad member 33 are inserted. The concave portion 634 is formed in a substantially concave shape so as to cover the thin part 332 and the convex portion 333 from the outside, and is provided so as to be able to engage with the convex portion 333 of the pad member 33.

In the pedal pad 13 according to the third embodiment, the convex portion 333 of the pad member 33 has the planar locking surfaces 335 that are not perpendicular with respect to the hinge shaft 633. Thus, in the pedal pad 13, the locking force in the removal direction M of the pad member 33 with respect to the hinge member 63 can be made relatively large. Accordingly, the third embodiment obtains the same effects as the first embodiment.

### Fourth Embodiment

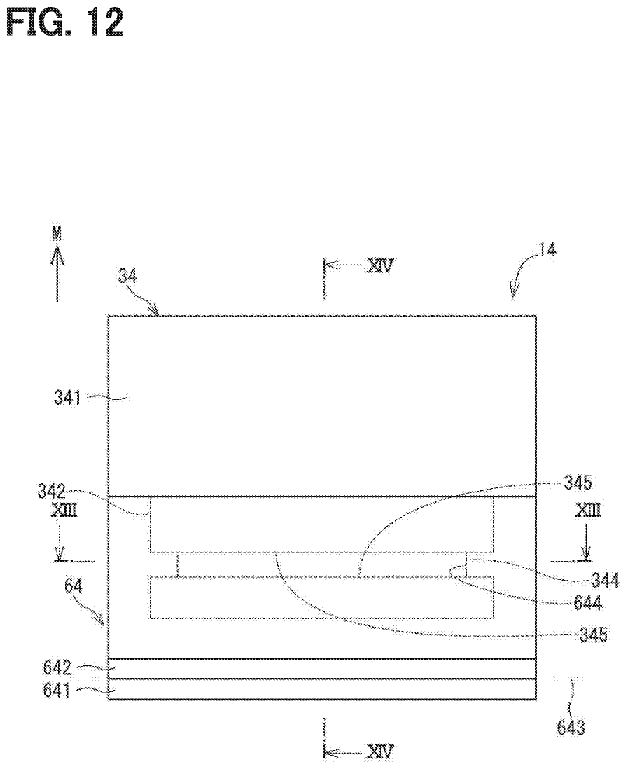

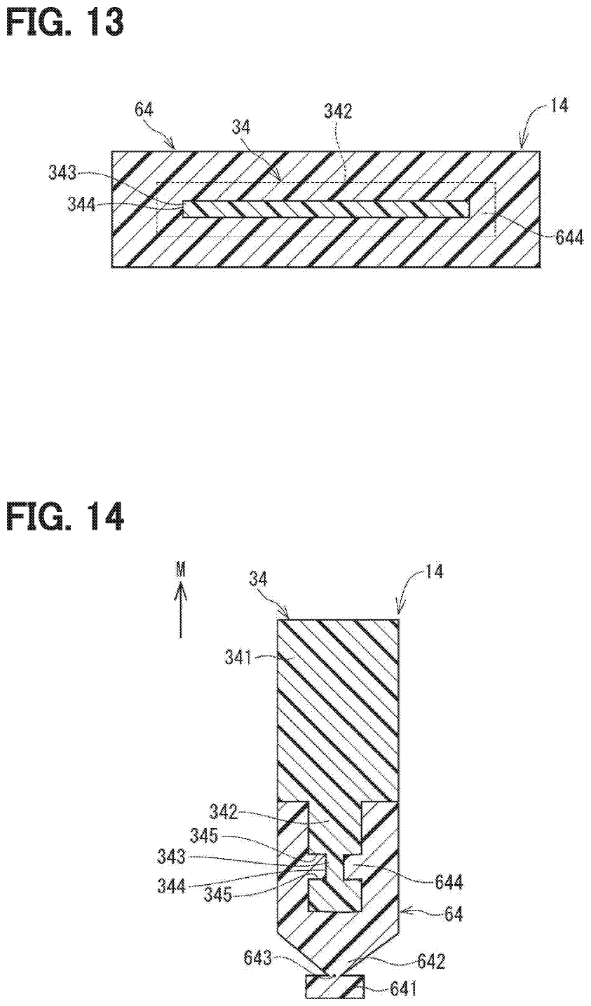

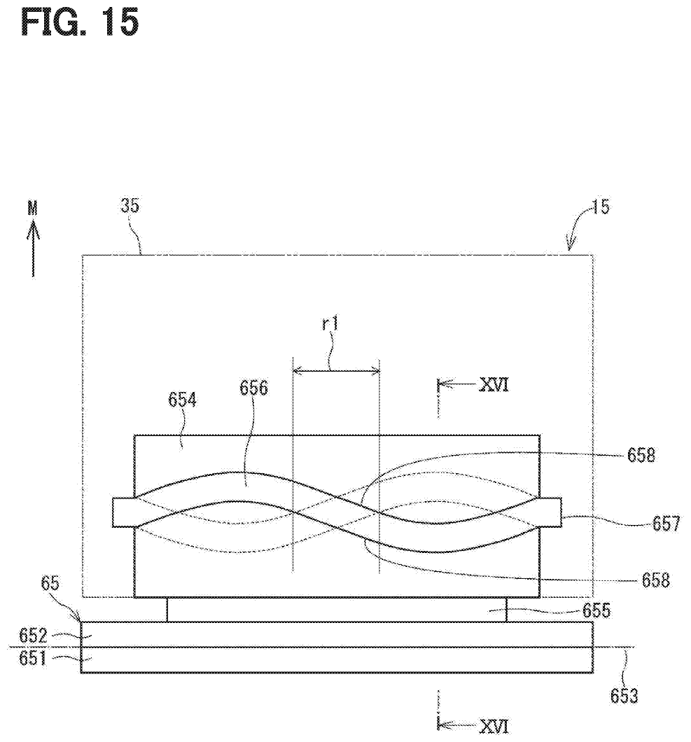

A pedal pad according to a fourth embodiment will be described with reference to FIGS. 12 to 14. FIG. 12 is a front view of the pedal pad 14 of the fourth embodiment, and is a view of the pedal pad 14 viewed from an angle corresponding to the direction A in FIG. 1. FIG. 13 is a cross-sectional view taken along a line XIII-XIII of FIG. 12, and FIG. 14 is a cross-sectional view taken along a line XIV-XIV of FIG. 9.

The pedal pad 14 according to the fourth embodiment has substantially the same appearance as the pedal pad 2 shown in FIGS. 1 and 2, and each member is represented by a simple shape in FIGS. 12 to 14. For example, the pad member 34 has substantially the same appearance as the pad member 3, but has an outer shape represented by two large and small plate-like quadrangular prism shapes. FIGS. 12 to 14 show the pedal pad 14 that is composed of a combination of the pad member 34 and the hinge member 64.

The pad member 34 has a thick part 341 and a thin part 342 that are substantially rectangular parallelepiped. The thick part 341 is formed so that an operator's foot can be placed on the outside surface. The thin part 342 is fixed to the hinge member 64. The thin part 342 is provided with a concave portion 343 that is formed in a direction substantially perpendicular to the direction M in which the pad member 34 is removed from the hinge member 64 and is formed in an annular shape. The concave portion 343 has a rectangular cross section (see FIG. 14) and is referred to as “one-side concave portion”. Other surfaces other than a bottom surface 344 among the surfaces forming the concave portion 343 are locking surfaces 345 formed non-parallel to the removal direction M of the pad member 34 with respect to the hinge member 64. That is, the locking surfaces 345 are formed so as to be non-perpendicular and flat with respect to the hinge shaft 643.

The hinge member 64 has a thinnest hinge shaft 643 between a bottom portion 641 and a thickness adjusting portion 642 having a triangular cross section (see FIG. 14). In the present embodiment, the hinge shaft 643 is provided so as to extend in a direction perpendicular to a removal direction M of the pad member 34 with respect to the hinge member 64. On an opposite side of the thickness adjusting portion 642 with respect to the hinge shaft 643, the hinge member 64 has a convex portion 644 into which the thin part 342 and the concave portion 343 of the pad member 34 are inserted. The convex portion 644 is formed in a substantially convex shape so as to cover the thin part 342 and the concave portion 343 from the outside, and is provided so as to be able to engage with the concave portion 343 of the pad member 34.

In the pedal pad 14 according to the fourth embodiment, the concave portion 343 of the pad member 34 has planar locking surfaces 345 that are non-perpendicular with respect to the hinge shaft 643. Thus, in the pedal pad 14, the locking force in the removal direction M of the pad member 34 with respect to the hinge member 64 can be made relatively large. In this way, the fourth embodiment achieves the advantages that are the same as those of the first embodiment.

### Fifth Embodiment

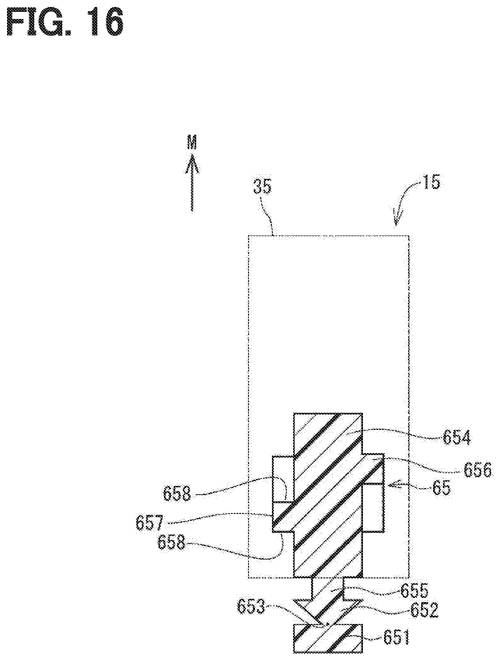

A pedal pad 15 according to the fifth embodiment has a hinge member 65, the hinge member 65 will be described with reference to FIGS. 15 and 16. FIG. 15 is a front view of the hinge member 65, in which only the hinge member 65 is viewed from the angle corresponding to the direction A in FIG. 1. FIG. 16 is a cross-sectional view taken along a line XVI-XVI in FIG. 15. The hinge member 65 becomes the pedal pad 15 by being combined with the pad member 35 which is simplified and shown by a two-dot chain line in FIGS. 15 and 16.

The hinge member 65 has a thinnest hinge shaft 653 between a bottom portion 651 and a thickness adjusting portion 652 having a triangular cross section (see FIG. 16). In the present embodiment, the hinge shaft 653 is provided so as to extend in a direction perpendicular to a removal direction M of the pad member 35 with respect to the hinge member 65. On an opposite side of the thickness adjusting portion 652 with respect to the hinge shaft 653, a connecting portion 655 for connecting the fixing portion 654 fixed to the pad member 35 and the thickness adjusting portion 652 is provided. The substantially rectangular parallelepiped fixing portion 654 is provided with a convex portion 656 that protrudes in a direction substantially perpendicular to the direction M in which the pad member 35 is removed from the hinge member 65 and is formed in an annular and wave shape. The convex portion 656 has a rectangular cross section (see FIG. 16) and is referred to as “one-side convex portion”. Other surfaces other than a top surface 657 among the surfaces forming the convex portion 656 are locking surfaces 658 formed non-parallel to the removal direction M of the pad member 35 with respect to the hinge member 65. A part of the locking surfaces 658, for example, a range r1 shown in FIG. 15 is formed to be planar. That is, a part of the locking surfaces 658 is formed so as to be non-perpendicular and flat with respect to the hinge shaft 653.

In the pedal pad 15 according to the fifth embodiment, the convex portion 656 of the hinge member 65 has the planar locking surfaces 658 that are not perpendicular with respect to the hinge shaft 653. Thus, in the pedal pad 15, the locking force in the removal direction M of the pad member 35 with respect to the hinge member 65 can be made relatively large. In this way, the fifth embodiment achieves the advantages that are the same as those of the first embodiment.

Further, since the convex portion 656 of the pedal pad 15 is formed in the wave shape, the locking force by the locking surface 658 is strengthened not only in the removal direction M but also in a direction deviating from the removal direction M or in a twisting direction.

### Sixth Embodiment

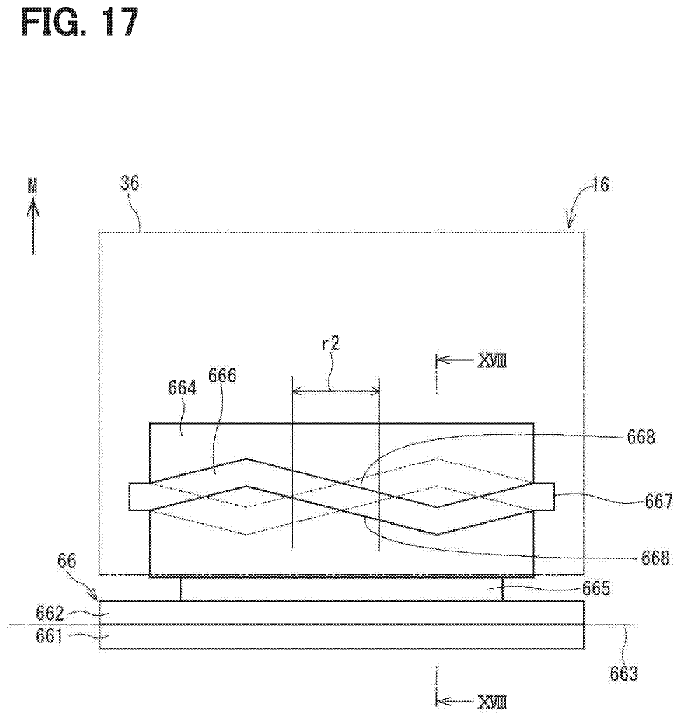

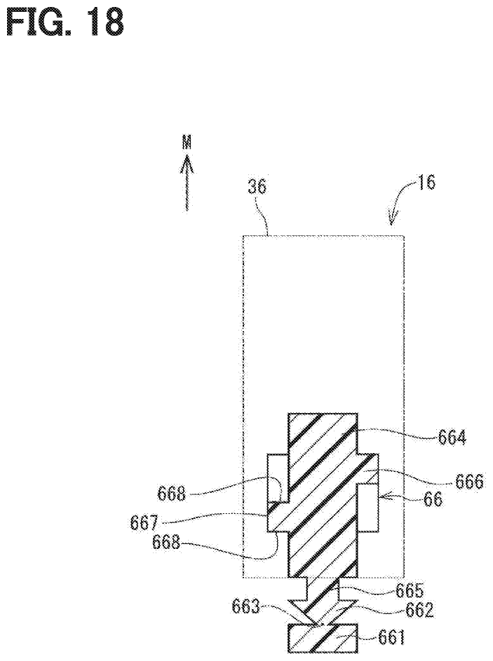

A pedal pad 16 according to the fifth embodiment has a hinge member 66, the hinge member 66 will be described with reference to FIGS. 17 and 18. FIG. 17 is a front view of the hinge member 66, in which only the hinge member 66 is viewed from the angle corresponding to the direction A in FIG. 1. FIG. 18 is a cross-sectional view taken along a line XVIII-XVIII in FIG. 17. The hinge member 66 becomes the pedal pad 16 by being combined with the pad member 36 which is simplified and shown by a two-dot chain line in FIGS. 17 and 18.

The hinge member 66 has a thinnest hinge shaft 663 between a bottom portion 661 and a thickness adjusting portion 662 having a triangular cross section (see FIG. 18). In the present embodiment, the hinge shaft 663 is provided so as to extend in a direction perpendicular to a removal direction M of the pad member 36 with respect to the hinge member 66. On an opposite side of the thickness adjusting portion 662 with respect to the hinge shaft 663, a connecting portion 665 for connecting the fixing portion 664 fixed to the pad member 36 and the thickness adjusting portion 662 is provided. The substantially rectangular parallelepiped fixing portion 664 is provided with a convex portion 666 that protrudes in a direction substantially perpendicular to the direction M in which the pad member 36 is removed from the hinge member 66 and is formed in an annular and zigzag shape. The convex portion 666 has a rectangular cross section (see FIG. 18) and is referred to as “one-side convex portion”. Other surfaces other than a top surface 667 among the surfaces forming the convex portion 666 are locking surfaces 668 formed non-parallel to the removal direction M of the pad member 36 with respect to the hinge member 66. A part of the locking surfaces 668, for example, a range r2 shown in FIG. 17 is formed to be planar. That is, a part of the locking surfaces 668 is formed so as to be non-perpendicular and flat with respect to the hinge shaft 663.

In the pedal pad 16 according to the sixth embodiment, the convex portion 666 of the hinge member 66 has the planar locking surfaces 668 that are not perpendicular with respect to the hinge shaft 663. Thus, in the pedal pad 16, the locking force in the removal direction M of the pad member 36 with respect to the hinge member 66 can be made relatively large. In this way, the sixth embodiment achieves the advantages that are the same as those of the first embodiment.

Further, since the convex portion 666 of the pedal pad 16 is formed in the zigzag shape, the locking force by the locking surface 668 is strengthened not only in the removal direction M but also in a direction deviating from the removal direction M or in a twisting direction.

### Seventh Embodiment

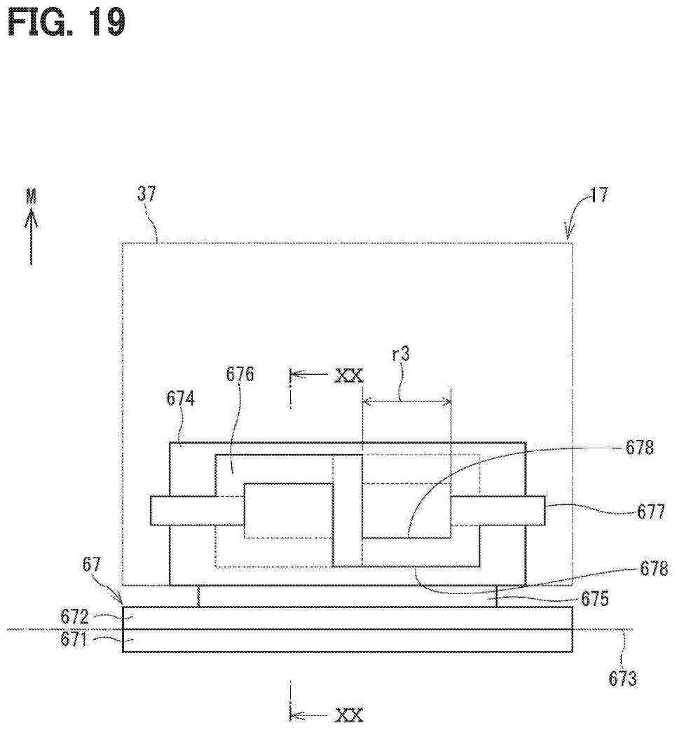

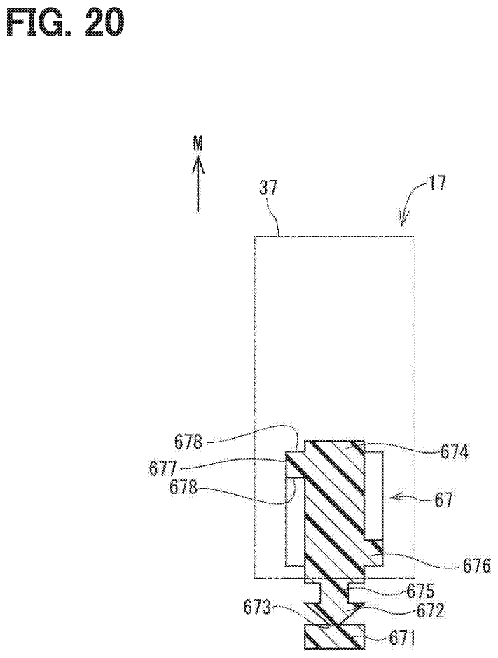

A pedal pad 17 according to the seventh embodiment has a hinge member 67, the hinge member 67 will be described with reference to FIGS. 19 and 20. FIG. 19 is a front view of the hinge member 67, in which only the hinge member 67 is viewed from the angle corresponding to the direction A in FIG. 1. FIG. 20 is a cross-sectional view taken along a line XX-XX of FIG. 19. The hinge member 67 becomes the pedal pad 17 by being combined with the pad member 37 which is simplified and shown by a two-dot chain line in FIGS. 19 and 20.

The hinge member 67 has a thinnest hinge shaft 673 between a bottom portion 671 and a thickness adjusting portion 672 having a triangular cross section (see FIG. 20). In the present embodiment, the hinge shaft 673 is provided so as to extend in a direction perpendicular to a removal direction M of the pad member 37 with respect to the hinge member 67. On an opposite side of the thickness adjusting portion 672 with respect to the hinge shaft 673, a connecting portion 675 for connecting the fixing portion 674 fixed to the pad member 37 and the thickness adjusting portion 672 is provided. The substantially rectangular parallelepiped fixing portion 674 is provided with a convex portion 676 that protrudes in a direction substantially perpendicular to the direction M in which the pad member 37 is removed from the hinge member 67 and is formed in an annular and in a so-called crank shape that beds at a right angle. The convex portion 676 has a rectangular cross section (see FIG. 20) and is referred to as “one-side convex portion”. Other surfaces other than a top surface 677 among the surfaces forming the convex portion 676 are locking surfaces 678 formed non-parallel to the removal direction M of the pad member 37 with respect to the hinge member 67. A part of the locking surfaces 678, for example, a range r3 shown in FIG. 19 is formed to be planar. That is, a part of the locking surfaces 678 is formed so as to be non-perpendicular and flat with respect to the hinge shaft 673.

In the pedal pad 17 according to the seventh embodiment, the convex portion 676 of the hinge member 67 has the planar locking surfaces 678 that are not perpendicular with respect to the hinge shaft 673. Thus, in the pedal pad 17, the locking force in the removal direction M of the pad member 37 with respect to the hinge member 67 can be made relatively large. In this way, the seventh embodiment achieves the advantages that are the same as those of the first embodiment.

Further, since the convex portion 676 of the pedal pad 17 is formed in the so-called crank shape that beds at a right angle, the locking force by the locking surface 678 is strengthened not only in the removal direction M but also in a direction deviating from the removal direction M or in a twisting direction.

### Eighth Embodiment

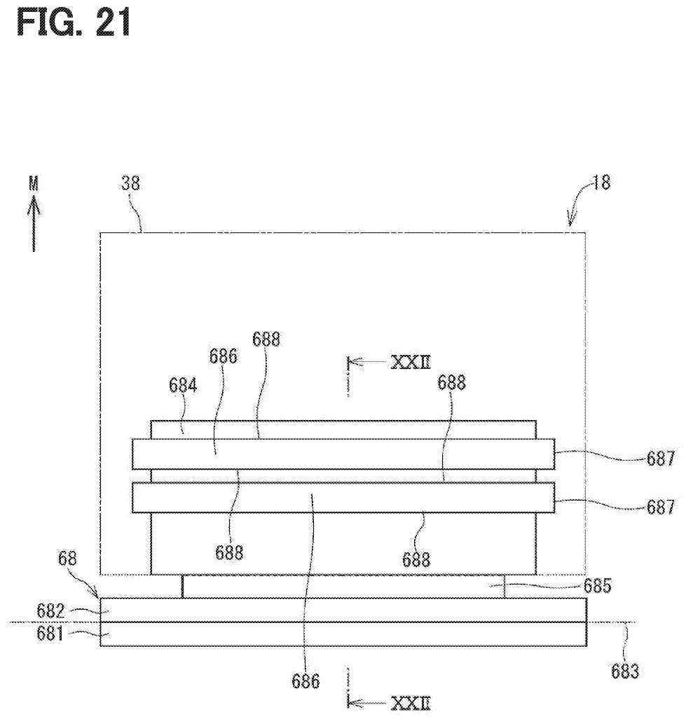

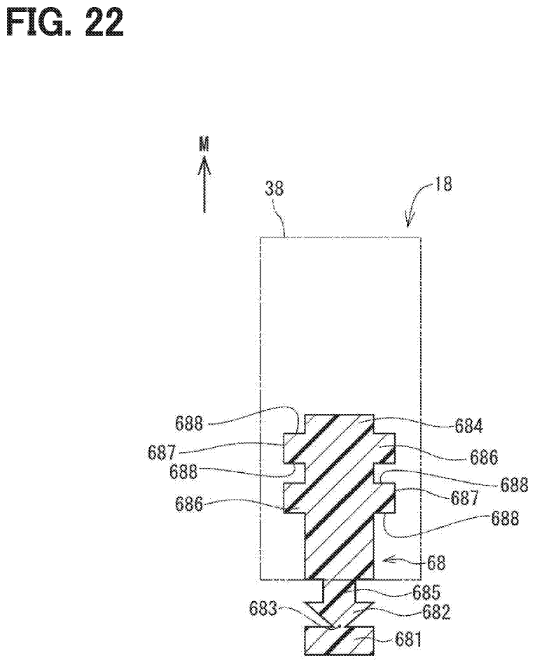

A pedal pad 18 according to the eighth embodiment has a hinge member 68, the hinge member 68 will be described with reference to FIGS. 21 and 22. FIG. 21 is a front view of the hinge member 68, in which only the hinge member 68 is viewed from the angle corresponding to the direction A in FIG. 1. FIG. 22 is a cross-sectional view taken along a line XXII-XXII of FIG. 21. The hinge member 68 becomes the pedal pad 18 by being combined with the pad member 38 which is simplified and shown by a two-dot chain line in FIGS. 21 and 22.

The hinge member 68 has a thinnest hinge shaft 683 between a bottom portion 681 and a thickness adjusting portion 682 having a triangular cross section (see FIG. 22). In the present embodiment, the hinge shaft 683 is provided so as to extend in a direction perpendicular to a removal direction M of the pad member 38 with respect to the hinge member 68. On an opposite side of the thickness adjusting portion 682 with respect to the hinge shaft 683, a connecting portion 685 for connecting the fixing portion 684 fixed to the pad member 38 and the thickness adjusting portion 682 is provided. The substantially rectangular parallelepiped fixing portion 684 is provided with two convex portions 686 that protrude in a direction substantially perpendicular to the direction M in which the pad member 38 is removed from the hinge member 68 and are formed in an annular shape. The convex portions 686 have a rectangular cross section (see FIG. 22) and is referred to as “one-side convex portion”. Other surfaces other than a top surface 687 among the surfaces forming each of two convex portions 686 are locking surfaces 688 formed non-parallel to the removal direction M of the pad member 38 with respect to the hinge member 68. That is, the locking surfaces 688 are formed so as to be non-perpendicular and flat with respect to the hinge shaft 683.

In the pedal pad 18 according to the eighth embodiment, the convex portion 686 of the hinge member 68 has the planar locking surfaces 688 that are not perpendicular with respect to the hinge shaft 683. Thus, in the pedal pad 18, the locking force in the removal direction M of the pad member 38 with respect to the hinge member 68 can be made relatively large. In this way, the eighth embodiment achieves the advantages that are the same as those of the first embodiment.

Further, since the pedal pad 18 has the two convex portions 686 having the locking surfaces 688, the locking force of the pad member 38 with respect to the hinge member 68 in the removal direction M can be further enhanced.

### Ninth Embodiment

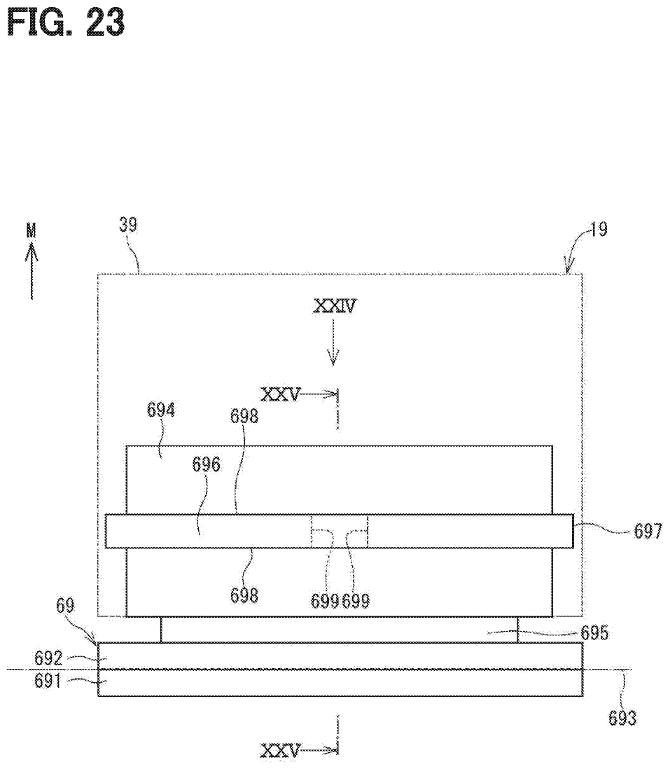

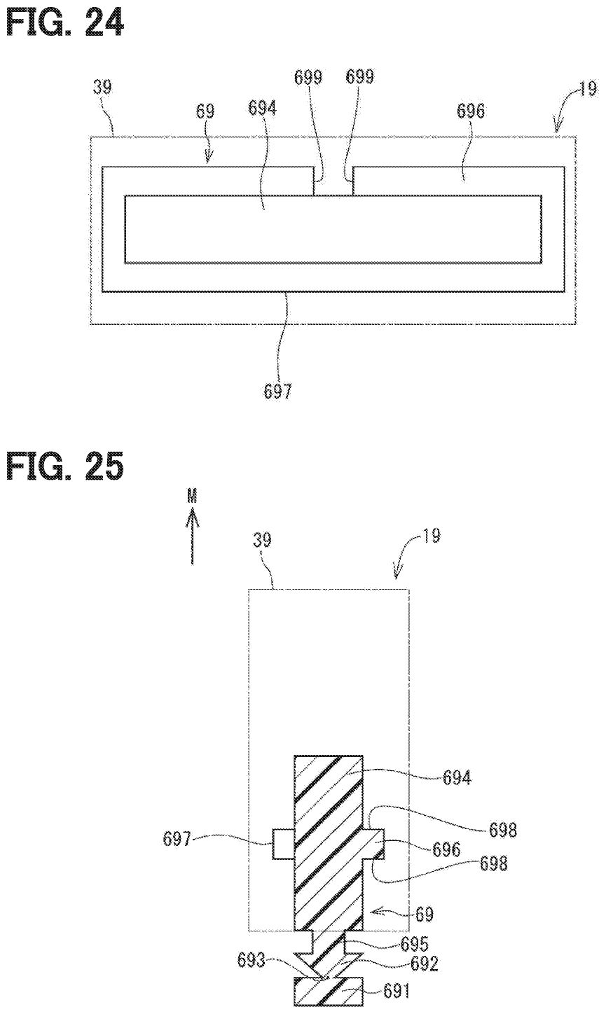

A pedal pad 19 according to the ninth embodiment has a hinge member 69, the hinge member 69 will be described with reference to FIGS. 23 to 25. FIG. 23 is a front view of the hinge member 69, in which only the hinge member 69 is viewed from the angle corresponding to the direction A in FIG. 1. FIG. 24 is a view taken along an arrow XXIV of FIG. 23, and FIG. 25 is a cross-sectional view taken along a line XXV-XXV of FIG. 23. The hinge member 69 becomes the pedal pad 19 by being combined with the pad member 39 which is simplified and shown by a two-dot chain line in FIGS. 23 to 25.

The hinge member 69 has a thinnest hinge shaft 693 between a bottom portion 691 and a thickness adjusting portion 692 having a triangular cross section (see FIG. 25). In the present embodiment, the hinge shaft 693 is provided so as to extend in a direction perpendicular to a removal direction M of the pad member 39 with respect to the hinge member 69. On an opposite side of the thickness adjusting portion 692 with respect to the hinge shaft 693, a connecting portion 695 for connecting the fixing portion 694 fixed to the pad member 39 and the thickness adjusting portion 692 is provided. The substantially rectangular parallelepiped fixing portion 694 is provided with convex portion 696 that protrudes in a direction substantially perpendicular to the direction M in which the pad member 39 is removed from the hinge member 69. The convex portions 696 have a rectangular cross section (see FIG. 25) and is referred to as “one-side convex portion”. The convex portion 696 is formed in a substantially C shape as shown in FIG. 24. Other surfaces other than a top surface 697 and end surfaces 699 positioned so as to face each other in a circumferential direction of the fixing portion 694 among the surfaces forming the convex portion 696 are planar locking surfaces 698 formed non-parallel to the removal direction M of the pad member 39 with respect to the hinge member 69. That is, the locking surfaces 698 are formed so as to be non-perpendicular and flat with respect to the hinge shaft 693.

In the pedal pad 19 according to the ninth embodiment, the convex portion 696 of the hinge member 69 has the planar locking surfaces 698 that are not perpendicular with respect to the hinge shaft 693. Thus, in the pedal pad 19, the locking force in the removal direction M of the pad member 39 with respect to the hinge member 69 can be made relatively large. In this way, the ninth embodiment achieves the advantages that are the same as those of the first embodiment.

### Tenth Embodiment

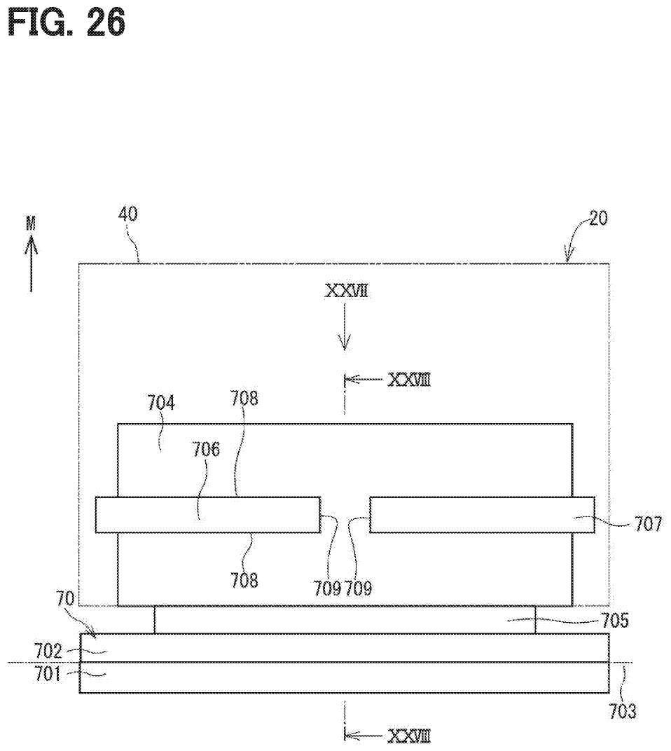

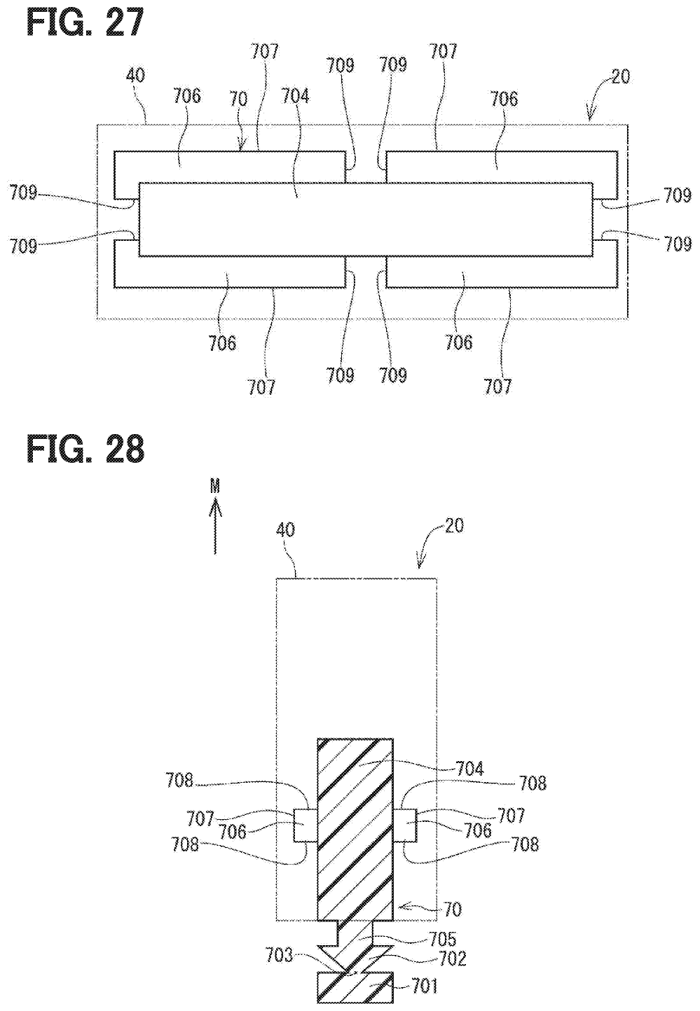

A pedal pad 20 according to the tenth embodiment has a hinge member 70, the hinge member 70 will be described with reference to FIGS. 26 to 28. FIG. 26 is a front view of the hinge member 70, in which only the hinge member 70 is viewed from the angle corresponding to the direction A in FIG. 1. FIG. 27 is a view taken along an arrow XXVII of FIG. 26, and FIG. 28 is a cross-sectional view taken along a line XXVIII-XXVIII of FIG. 26. The hinge member 70 becomes the pedal pad 20 by being combined with the pad member 40 which is simplified and shown by a two-dot chain line in FIGS. 26 to 28.

The hinge member 70 has a thinnest hinge shaft 703 between a bottom portion 701 and a thickness adjusting portion 702 having a triangular cross section (see FIG. 28). In the present embodiment, the hinge shaft 703 is provided so as to extend in a direction perpendicular to a removal direction M of the pad member 40 with respect to the hinge member 70. On an opposite side of the thickness adjusting portion 702 with respect to the hinge shaft 703, a connecting portion 705 for connecting the fixing portion 704 fixed to the pad member 40 and the thickness adjusting portion 702 is provided. The substantially rectangular parallelepiped fixing portion 704 is provided with convex portion 706 that protrudes in a direction substantially perpendicular to the direction M in which the pad member 40 is removed from the hinge member 70. The convex portions 706 have a rectangular cross section (see FIG. 28) and is referred to as “one-side convex portion”. As shown in FIG. 27, the hinge member 70 has four convex portions 706 so as to be arranged at substantially equal intervals in the circumferential direction of the fixing portion 704. Other surfaces other than a top surface 707 and end surfaces 709 positioned so as to face each other in a circumferential direction of the fixing portion 704 among the surfaces forming the convex portion 706 are planar locking surfaces 708 formed non-parallel to the removal direction M of the pad member 40 with respect to the hinge member 70. That is, the locking surfaces 708 are formed so as to be non-perpendicular and flat with respect to the hinge shaft 703.

In the pedal pad 20 according to the tenth embodiment, the convex portion 706 of the hinge member 70 has the planar locking surfaces 708 that are not perpendicular with respect to the hinge shaft 703. Thus, in the pedal pad 20, the locking force in the removal direction M of the pad member 40 with respect to the hinge member 70 can be made relatively large. In this way, the tenth embodiment achieves the advantages that are the same as those of the first embodiment.

### Eleventh Embodiment

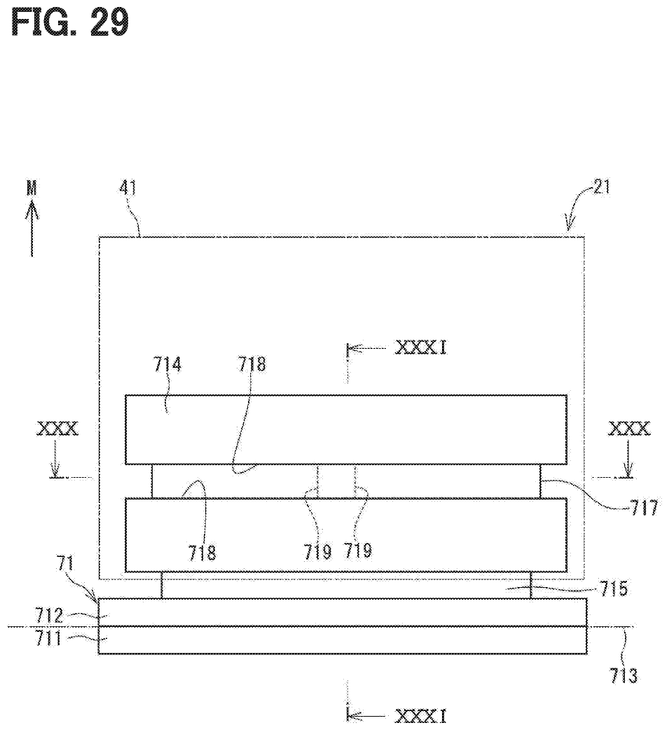

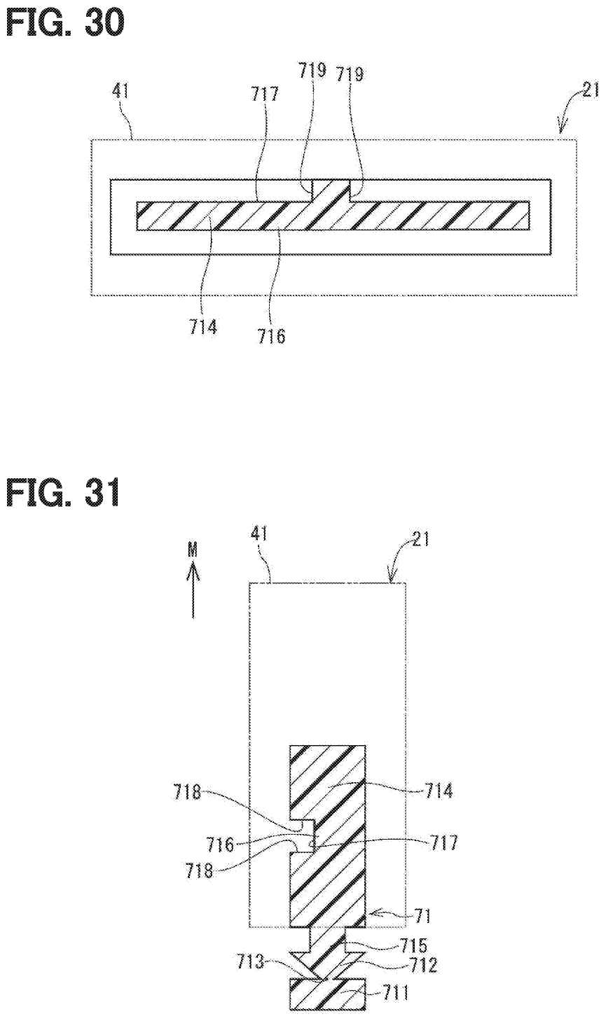

A pedal pad 21 according to the eleventh embodiment has a hinge member 71, the hinge member 71 will be described with reference to FIGS. 29 to 31. FIG. 29 is a front view of the hinge member 71, in which only the hinge member 71 is viewed from the angle corresponding to the direction A in FIG. 1. FIG. 30 is across-sectional view taken along a line XXX-XXX of FIG. 29, and FIG. 31 is a cross-sectional view taken along a line XXXI-XXXI of FIG. 29. The hinge member 71 becomes the pedal pad 21 by being combined with the pad member 41 which is simplified and shown by a two-dot chain line in FIGS. 29 to 31.

The hinge member 71 has a thinnest hinge shaft 713 between a bottom portion 711 and a thickness adjusting portion 712 having a triangular cross section (see FIG. 31). In the present embodiment, the hinge shaft 713 is provided so as to extend in a direction perpendicular to a removal direction M of the pad member 41 with respect to the hinge member 71. On an opposite side of the thickness adjusting portion 712 with respect to the hinge shaft 713, a connecting portion 715 for connecting the fixing portion 714 fixed to the pad member 41 and the thickness adjusting portion 712 is provided. The substantially rectangular parallelepiped fixing portion 714 is provided with a concave portion 716 that is formed in a direction substantially perpendicular to the direction M in which the pad member 41 is removed from the hinge member 71. The concave portion 716 has a rectangular cross section (see FIG. 31) and is referred to as “one-side concave portion”. The concave portion 716 is formed in a substantially C shape as shown in FIG. 30. Other surfaces other than a bottom surface 717 and end surfaces 719 located at a predetermined distance from each other in a circumferential direction of the fixing portion 714 among the surfaces forming the concave portion 716 are planar locking surfaces 718 formed non-parallel to the removal direction M of the pad member 41 with respect to the hinge member 71. That is, the locking surfaces 718 are formed so as to be non-perpendicular and flat with respect to the hinge shaft 713.

In the pedal pad 21 according to the eleventh embodiment, the concave portion 716 of the hinge member 71 has the planar locking surfaces 718 that are not perpendicular with respect to the hinge shaft 713. Thus, in the pedal pad 21, the locking force in the removal direction M of the pad member 41 with respect to the hinge member 71 can be made relatively large. In this way, the eleventh embodiment achieves the advantages that are the same as those of the first embodiment.

### Twelfth Embodiment

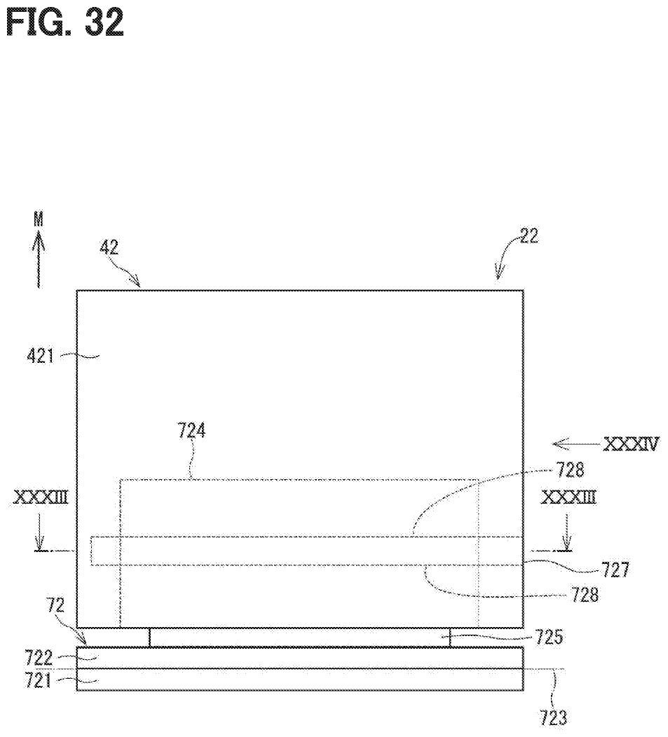

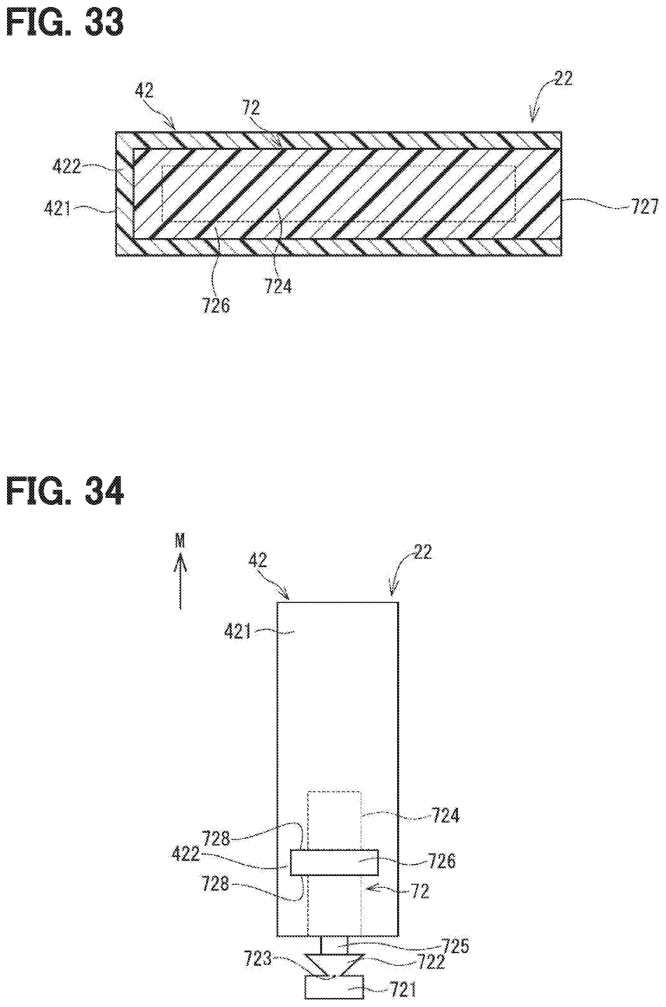

A pedal pad 22 according to the twelfth embodiment will be described with reference to FIGS. 32 to 34. FIG. 32 is a front view of the pedal pad 22 when the pedal pad 22 is viewed from an angle corresponding to the direction A in FIG. 1 FIG. 33 is a cross-sectional view taken along a XXXIII-XXXIII of FIG. 32, and FIG. 34 is a view taken along an arrow XXXIV of FIG. 32.

The pedal pad 22 according to the twelfth embodiment has substantially the same appearance as the pedal pad 2 shown in FIGS. 1 and 2, and each member is represented by a simple shape in FIGS. 32 to 34. For example, the pad member 42 has substantially the same appearance as the pad member 3, but has an outer shape represented by a plate-like quadrangular prism shape. FIGS. 32 to 34 show the pedal pad 22 that is composed of a combination of the pad member 42 and the hinge member 72.

The hinge member 72 has a thinnest hinge shaft 723 between a bottom portion 721 and a thickness adjusting portion 722 having a triangular cross section (see FIG. 34). In the present embodiment, the hinge shaft 723 is provided so as to extend in a direction perpendicular to a removal direction M of the pad member 42 with respect to the hinge member 72. On an opposite side of the thickness adjusting portion 722 with respect to the hinge shaft 723, a connecting portion 725 for connecting the fixing portion 724 fixed to the pad member 42 and the thickness adjusting portion 722 is provided. The substantially rectangular parallelepiped fixing portion 724 is provided with two convex portions 726 that protrude in a direction substantially perpendicular to the direction M in which the pad member 42 is removed from the hinge member 72 and are formed in an annular shape. The convex portions 726 have a rectangular cross section (see FIG. 34) and is referred to as “one-side convex portion”. Other surfaces other than a top surface 727 among the surfaces forming the convex portion 726 are planar locking surfaces 728 formed non-parallel to the removal direction M of the pad member 42 with respect to the hinge member 72. That is, the locking surfaces 728 are formed so as to be non-perpendicular and flat with respect to the hinge shaft 693.

The pad member 42 has a main body 421 and a concave portion 422. The main body 421 is formed in a substantially concave shape so as to cover the fixing portion 724 and a part of the convex portion 726 of the hinge member 72. The main body 421 is formed so that an operator's foot can be placed on the outside surface. The concave portion 422 is provided inside the main body 421 and is formed so as to be able to engage with the convex portion 726 of the hinge member 72. In the present embodiment, the concave portion 422 is formed in a substantially C shape as shown in FIG. 33. Thereby, as shown in FIG. 33, a part of the top surface 727 of the convex portion 726 of the hinge member 72 is exposed to the outside.

In the pedal pad 22 according to the twelfth embodiment, the convex portion 726 of the hinge member 72 has the planar locking surfaces 728 that are not perpendicular with respect to the hinge shaft 723. Thus, in the pedal pad 22, the locking force in the removal direction M of the pad member 42 with respect to the hinge member 72 can be made relatively large. In this way, the twelfth embodiment achieves the advantages that are the same as those of the first embodiment.

### Other Embodiments

In the pedal pads according to the fifth to eighth embodiments and the tenth embodiment, the hinge members 65, 66, 67, 68, and 70 have the convex portions 656, 666, 676, 686, and 706. However, the hinge members 65, 66, 67, 68, 70 may be provided with “one-side concave portions” and the pad members may be provided with “one-side convex portions”.

The pedal pads according to the first to twelfth embodiments are applied to the organ type accelerator device, but may be applied to a so-called hanging type accelerator device or the like, or a brake pedal, a clutch pedal or the like.

In the eighth embodiment, the hinge member 68 has two convex portions 686 having the same shape. However, the hinge member may have three or more “one-side convex portions”. When a plurality of “one-side convex portions” are provided, one or two or more of them may have a shape different from that of the other convex portions. Further, a plurality of “one-side concave portions” may be provided similarly to the “one-side convex portions”.

Each of the “one-side convex portion” or the “one-side concave portion” of the first to twelfth embodiments has a rectangular cross-sectional shape. However, the cross-sectional shape of the “one-side convex portion” or the “one-side concave portion” may be a triangle, a semicircle, or the like.

The present disclosure should not be limited to the embodiments described above, and various other embodiments may be implemented without departing from the scope of the present disclosure.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

In an assumable example, a pedal device detects an operation amount of a depressing operation by an operator's foot. The pedal device includes a pedal pad that is relatively movable with respect to a base of the pedal device by the depressing operation by the operator's foot. For example, Patent Document 1 (JP 2009-101966 A) discloses a pedal pad including a pad member and a hinge member. The pad member is operated by a driver to depress, and the hinge member is provided at one end of the pad member and connects the pad member to a base of the pedal device in a rotatable manner.

In the pedal pad described in Patent Document 1, the hinge member has a projected part that can be engaged with a recessed part of the pad member. However, since the projected part is formed in a columnar shape, a locking force between the pad member and the hinge member is relatively small. In order to prevent the pad member from coming off from the hinge member, it is necessary to provide a plurality of projected parts and recessed parts. Therefore, the size of the pad member and the hinge member increases, and the size of the pedal device including the pedal pad also increases. The present disclosure has been made in view of the above problems, and an object of the present disclosure is to provide a pedal pad that can reliably prevent the pad member from coming off the hinge member while suppressing the increase in the size of the pad member and the hinge member.

The present disclosure is related to a pedal pad for applying to a pedal device that outputs a signal corresponding to an operation amount of a depressing operation by an operator's foot. The pedal pad includes a pad member and a hinge member. The pad member is depressed by an operator's foot. The hinge member connects the pad member and a base of the pedal device. In the pedal pad of the present disclosure, one of the pad member or the hinge member has a one-side convex portion or one-side concave portion that is locked to the other of the pad member or the hinge member, and that includes a planar locking surface not to be perpendicular with respect to a hinge shaft.

In the pedal pad of the present disclosure, one of the pad member or the hinge member has the one-side convex portion or the one-side concave portion that includes a planar locking surface that is non-perpendicular to the hinge shaft. Since a removable direction of the pad member with respect to the hinge member is perpendicular to the hinge shaft, the locking surface can exert an locking force against the removal direction. Further, since the locking surface is formed in a flat shape, the locking force can be increased without increasing the size. Accordingly, for example, when the pedal pad of the present disclosure is applied to an organ-type pedal device used in a vehicle, the size of the pedal device can be suppressed from being increased, so that deterioration in mountability to the vehicle can be prevented. As described above, the pedal pad according to the present disclosure can reliably prevent the pad member and the hinge member from coming off while suppressing an increase in size.

1. A pedal pad for applying to a pedal device that outputs a signal corresponding to an operation amount of a depressing operation by an operator's foot, the pedal pad comprising:
a pad member that is depressed by the operator's foot; and
a hinge member that connects the pad member and a base of the pedal device; wherein
one of the pad member or the hinge member has a one-side convex portion or one-side concave portion that is locked to the other of the pad member or the hinge member, and that includes a planar locking surface which is non-perpendicular with respect to a hinge shaft and is formed in an annular shape.

2. The pedal pad according to claim 1, wherein
the locking surface is formed parallel to the hinge shaft.

3. The pedal pad according to claim 1, wherein:
a plurality of the locking surfaces are formed.

4. The pedal pad according to claim 1, wherein
the hinge member is elastically deformed along the hinge shaft by the depressing operation with the operator, and
the hinge shaft extends in a direction perpendicular to a removal direction (M) of the pad member.

5. The pedal pad according to claim 1, wherein
the hinge member has a fixing portion fixed to the pad member and one-side convex portion,
the pad member has a main body and a concave portion, and
the main body is formed in a concave shape to cover the fixing portion and the one-side convex portion so that the concave portion engages with the convex portion of the hinge member.

6. The pedal pad according to claim 1, wherein
the pad member has a thick part on which the operator's foot is placed, a thin part fixed to the hinge member, and the one-side concave portion,
the hinge member has a convex portion into which the thin part and the concave portion of the pad member are inserted, and
the convex portion covers the thin part and the concave portion from outside, and engages with the concave portion of the pad member.

7. A pedal device for outputting a signal corresponding to an operation amount of a depressing operation by an operator's foot, the pedal device comprising:
a base fixed to be relatively immovable with respect to a fixed object on which the pedal device is mounted;
a pedal pad including a pad member that is depressed by the operator's foot, and a hinge member into which the pad member is inserted and locked and that connects the base and the pad member; and
a sensor configured to detect a rotation angle of the pad member with respect to the base; wherein
the hinge member is elastically deformed along a hinge shaft by the depressing operation with the operator's foot, and
one of the pad member or the hinge member has a one-side convex portion or a one-side concave portion includes a planar locking surface which is non-perpendicular with respect to the hinge shaft and is formed in an annular shape.

8. The pedal device according to claim 7, wherein
the hinge shaft is provided so as to extend in a direction perpendicular to a removal direction of the pad member with respect to the hinge member.

9. The pedal device according to claim 8, wherein
the hinge member has a fixing portion fixed to the pad member, a thickness adjusting portion connected to the hinge shaft, a connecting portion connected the fixing portion and the thickness adjusting portion, and the convex portion or the concave portion, and
the pad member is formed in a concave shape so as to cover the fixing portion and the convex portion or the concave portion of the hinge member.

10. The pedal device according to claim 9, wherein
the convex portion of the hinge member has locking surfaces formed so as to be non-perpendicular and flat with respect to the hinge shaft.

11. The pedal device according to claim 8, wherein
the pad member has a thick part, a thin part, and a convex portion provided on the thin part, and
the hinge member has a thickness adjusting portion connected to the hinge shaft and a concave portion formed in a concave portion to cover the thin part and the convex portion of the pad member from outside.

12. The pedal device according to claim 11, wherein
the convex portion of the pad member has locking surfaces formed so as to be non-perpendicular and flat with respect to the hinge shaft.
